(19) United States
(12) Patent Application Publication
(10) Pub. No.: US 2006/0215836 A1
(43) Pub. Date: Sep. 28, 2006

(54) Electronic device holder

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/085,570

(22) Filed: Mar. 22, 2005

(51) Int. Cl. H04M 1/00

(52) U.S. Cl. 379/455

(57) ABSTRACT

The present invention is to provide an electronic device holder comprising a body and a clamping assembly, wherein the body is disposed between two sides of the clamping assembly, at least one clamp is slidably connected to either side of the clamping assembly and is provided externally of the body, and a base is provided at bottom of the body and is adapted to support an electronic device. Such that when the electronic device is held by the holder, both sides of the clamping assembly can retract toward the body so as to firmly clamp the electronic device in cooperation with the clamps. Most importantly, the clamps can slide to expose controls at both sides of the electronic device.

### FIELD OF THE INVENTION

The present invention relates to holding equipment and more particularly to a holder for firmly supporting and fastening an electronic device (e.g., cellular phone) while permitting an easy access to controls at both sides thereof for using same.

### BACKGROUND OF THE INVENTION

A conventional holder 90 for holding an electronic device (e.g., cellular phone as shown) is illustrated in FIG. 1. The holder 90 comprises an elongate body 91, a slot 911, and two opposite walls 93. The walls 93 are located at both sides of the body 91 and are integrally formed therewith. The slot 911 is formed on a front surface of the body 91. The slot 911 is adapted to receive the electronic device therein. Further, the walls 93 are adapted to firmly clamp the electronic device. As a result, the electronic device is prevented from disengaging with the holder 90. Otherwise, the electronic device may be damaged, once it falls onto the ground accidentally.

A plurality of controls (e.g., power connector, camera port, earphone jack, etc.) are typically provided at both sides of the electronic device. However, it may not be easy to access the controls at both sides of the electronic device when the electronic device is held in the slot 911 of the body 91 (i.e., shielded by the walls 93). As such, a user has to remove the holder from the holder 90 prior to using the controls. In short, the provision of the walls 93 hinders the operation of the electronic device at both sides. Hence, a need has arisen for an improved electronic device holder.

### SUMMARY OF THE INVENTION

After considerable research and experimentation, a novel electronic device holder according to the present invention has been devised so as to overcome the above drawback of the prior art.

It is an object of the present invention to provide a device for holding an electronic device. The holding device comprises a body and a clamping assembly. The body is disposed between two sides of the clamping assembly. The body and the clamping assembly are also formed together. At least one clamp is slidably connected to either side of the clamping assembly and is provided externally of the body. A base is provided at bottom of the body and is adapted to support an electronic device. The above components are constituent components of the holder. In the case of the electronic device held by the holder, both sides of the clamping assembly can retract toward the body so as to firmly clamp the electronic device in cooperation with the clamps. Most importantly, the clamps can slide to expose controls at both sides of the electronic device. By utilizing this holding device an easy access of the controls can be carried out and the prior problem of the controls being shielded by the fixed walls is solved.

The above and other objects, features and advantages of the present invention will become apparent from the following detailed description taken with the accompanying drawings.

### BRIEF DESCRIPTION OF THE DRAWINGS

FIG. 1 is a perspective view of a conventional electronic device holder;

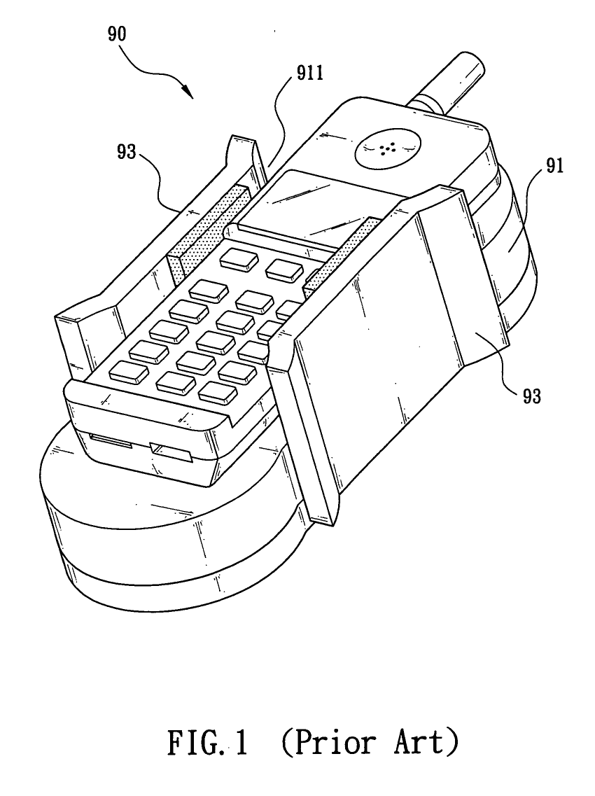

FIG. 2 is an exploded perspective view of a preferred embodiment of electronic device holder according to the invention;

FIG. 3 is a perspective view of the assembled holder in FIG. 2;

FIG. 4 is an exploded view of the components except the back panel, the clamps, and the support member in FIG. 2; and

FIG. 5 is an environmental view of the holder with an electronic device held therein, the holder being about to secure to top of a support.

### DETAILED DESCRIPTION OF THE PREFERRED EMBODIMENTS

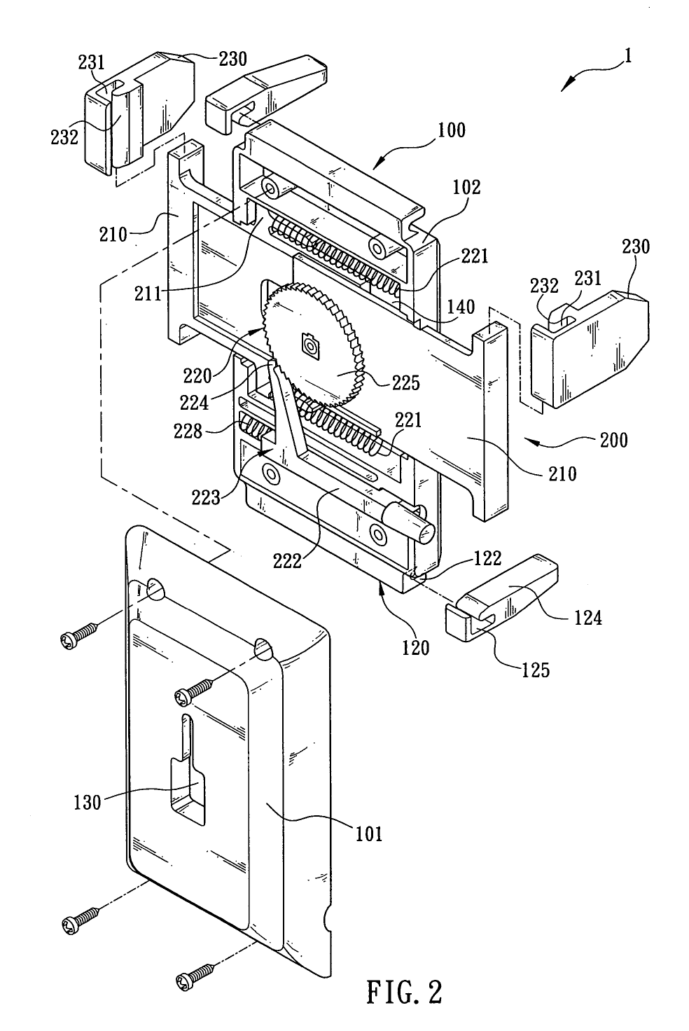

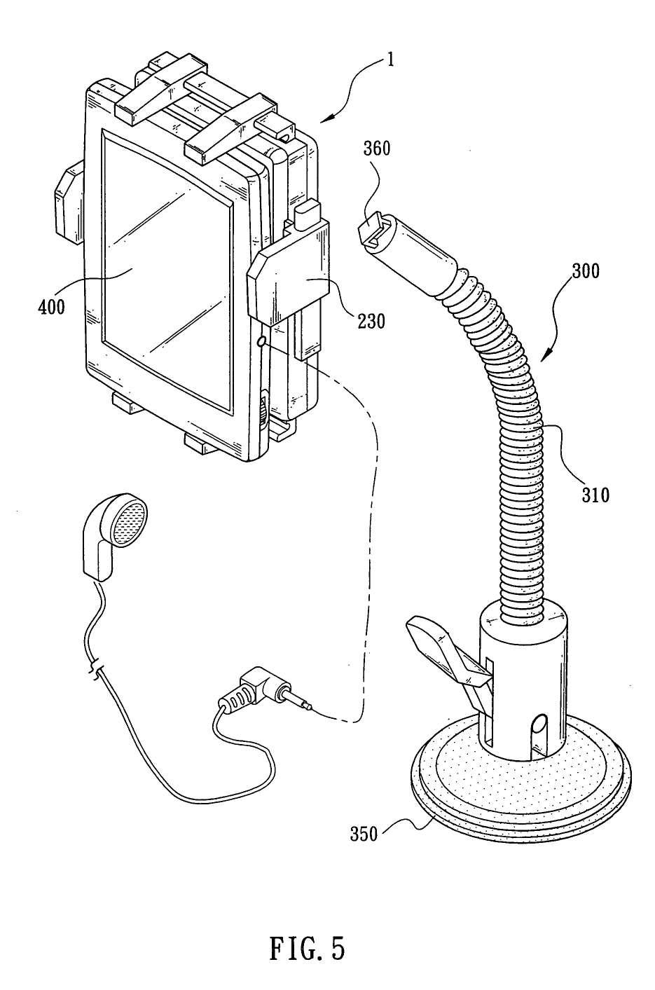

Referring to FIGS. 2 and 5, there is shown an electronic device holder according to a preferred embodiment of the invention. It comprises a body 100 and a clamping assembly 200. Both sides of the clamping assembly 200 are adapted to retract toward or extend from the body 100. The body 100 and the clamping assembly 200 are formed together. At least one clamp (one is shown) 230 is slidably connected to either side of the clamping assembly 200 and is provided externally of the body 100. A base 120 is provided at bottom of the body 100 and is adapted to support an electronic device 400. In other words, the holder 1 consists of the body 100, the clamping assembly 200, the clamps 230, and the base 120. In the case of the electronic device 400 held by the holder 1, the clamping assembly 200 can retract toward the body 100 so as to firmly clamp the electronic device 400 in cooperation with the clamps 230. Also, the clamps 230 may slide to expose controls at both sides of the electronic device 400. As a result, an easy access of the controls can be carried out and the prior problem of the controls being shielded by the fixed walls is solved.

Referring to FIG. 2 again, in an embodiment of the invention the clamping assembly 200 comprises two plates 210 and a locking assembly 220. The locking assembly 220 is provided at a joining portion of the plates 210 for connecting the plates 210 together. As such, the locking assembly 220 is adapted to operate to move the plates 210 toward the body 100 (i.e., retracting) or away from the body 100 (i.e., extending).

Referring to FIG. 2 again, in the embodiment, a longitudinal slot 231 is in formed at one end of the clamp 230. The slot 231 has a transverse section conformed to that of either side of the clamp 230 externally of the body 100. An opening 232 is formed at mouth of the slot 231 to communicate the slot 231 with outside of the clamp 230. Thus, the clamp 230 is adapted to put on one side of the plate 210 by sliding down along the slot 231 and the opening 232. Further, the clamp 230 may slide along either side of the clamping assembly 200 after being in place.

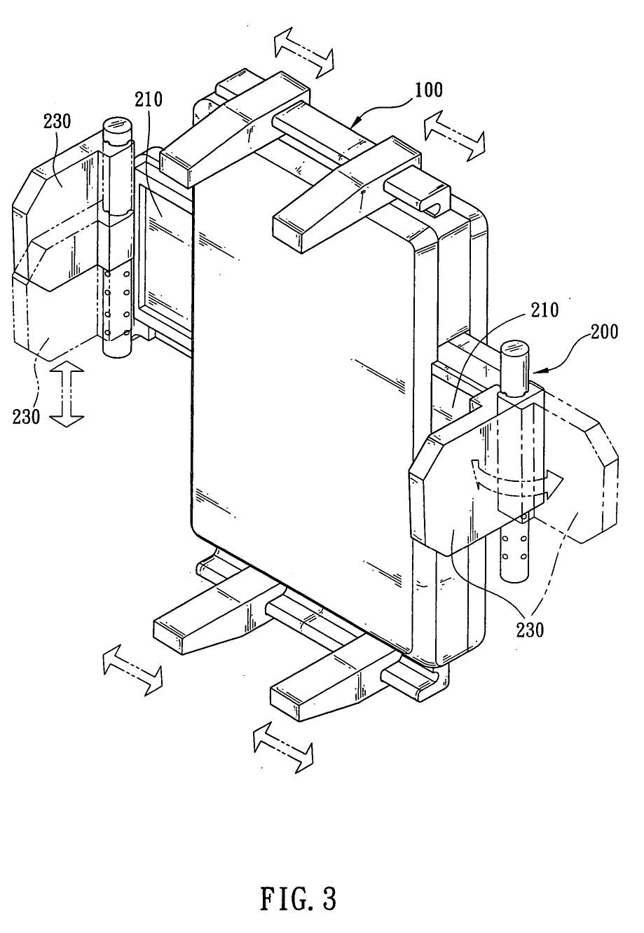

Referring to FIGS. 3 and 5, in another embodiment the clamp 230 is adapted to pivot about one side (i.e., outer side) of the plate 210. That is, the clamp 230 is adapted to pivot away from the body 100 so as to create space for exposing a plurality of controls (e.g., volume button, camera port, earphone jack, power connector, etc.) at both sides of the electronic device 400. As an end, an easy access and use of the control can be achieved.

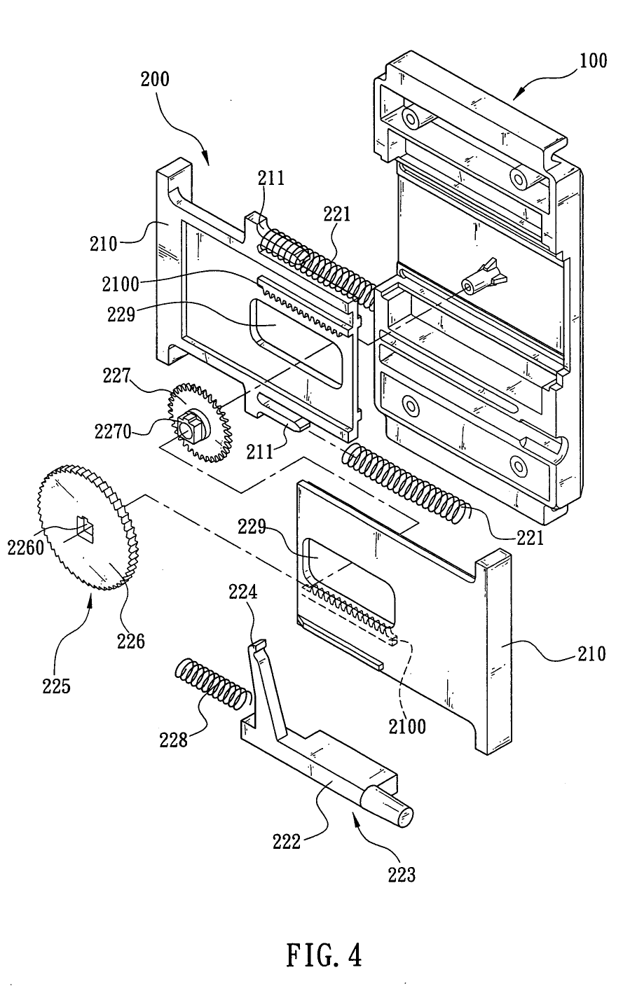

Referring to FIG. 4 in conjunction with FIG. 2, in the embodiment the plate 210 comprises at least one transverse projecting bar (one is shown) 211 at each of its bottom and top proximate the locking assembly 220. The locking assembly 220 comprises at least one first resilient member (e.g., spring) (two are shown) 221, a second resilient member 228, a gear assembly 225, and a return member (e.g., release lever) 223. One end of the first resilient member 221 is put on either bar 211 and the other end thereof is urged against the body 100. The gear assembly 225 is located at center of the clamping assembly 200. The return member 223 comprises a shank 222 having an outer end projecting from a side surface of the body 100. As such, a user may press the outer end of the return member 223 in operation. One end of the second resilient member 228 is urged against the other end of the shank 222. A pawl 224 is obliquely projected from top of the shank 222 toward the gear assembly 225. In the embodiment, the pawl 224 is caught and held by the tooth of the gear assembly 225. As such, in the case of the plates 210 retracted toward the body 100, the gear assembly 225 is driven to rotate with the first resilient members 221 being compressed. After stopping the retracting operation of the plates 210 toward the body 100, the pawl 224 is caught and held by the tooth of the gear assembly 225. As a result, the plates 210 are prevented from further movement. This completes the width adjustment of the holder 1 for conforming to width of the electronic device 400 by operating the clamping assembly 200. Further, for activating the return member 223 a user has to press the outer end of the shank 222. And in turn, the second resilient member 228 is compressed. At the same time, the pawl 224 disengages with the tooth of the gear assembly 225. Accordingly, the plates 210 extend from the body 100 due to the expansion of the first resilient members 221. Finally, stop exerting force on the shank 222 and the shank 22 and the return member 223 thus returns to its original, non-operating position due to the expansion of the second resilient member 228.

Referring to FIG. 4 again, in the embodiment the plate 210 comprises a rectangular opening 229 disposed corresponding to the gear assembly 225. One plate 210 further comprises a toothed bar 2100 formed above its opening 229 and the other plate 210 further comprises a toothed bar 2100 formed below its opening 229 in which either toothed bar 2100 is adapted to mesh with the teeth of the gear assembly 225. The gear assembly 225 comprises a large first gear 226 and a small second gear 227. The first gear 226 comprises a central first connecting member (e.g., pin hole) 2260. The first gear 226 is adapted to mesh with the lower toothed bar 2100. Similarly, the second gear 227 comprises a central second connecting member (e.g., pin block) 2270. The second gear 227 is adapted to mesh with the upper toothed bar 2100. The second connecting member 2270 and the first connecting member 2260 are secured together in one opening 229 (i.e., one in the right plate 210). As such, the gears 226 and 227 can rotate synchronously. Further, tip of the pawl 224 is caught and held by the tooth of the first gear 226 for only allowing the gear assembly 225 to rotate in one direction when the plates 210 are retracting toward the body 100. Namely, the other opposite rotation of the gear assembly 225 is prevented. As such, the plates 210 are unable to extend out of the body 100 by expanding the first resilient members 221. The gears 226 and 227 are adapted to rotate in one of two conditions as below.

(i) In the case of the plates 210 retracted toward the body 100, the first gear 226 rotates in one direction (i.e., not obstructed by the pawl 224). As such, both the gears 226 and 227 are driven to rotate.

(ii) In the case of the outer end of the shank 222 pressed, the second resilient member 228 is compressed. At the same time, the pawl 224 disengages with the tooth of the first gear 226 to allow the gear assembly 225 to rotate in the other opposite direction until the gear assembly 225 returns to its original position and portions of the plates 210 projected from the body 100 due to the expansion of the second resilient member 228.

Referring to FIGS. 2 and 5 again, in the embodiment the base 120 comprises a lengthwise rail 122 and a plurality of support members 124. The support members 124 are slidably secured to the rail 122 for supporting the electronic device 400. The support member 124 has a groove 125 proximate one end. The groove 125 has a longitudinal section conformed to that of the rail 122. As such, the support member 124 is able to put on the rail 122 by inserting the rail 122 through the groove 125. Distance between the support members 124 can be adjusted based on the width of the electronic device 400 so as to achieve the purpose of supporting the electronic device 400.

Referring to FIGS. 2 and 5 again, in another embodiment the body 100 comprises a substantially upright support 300 disposed opposite the electronic device 400 held in the body 100. Bottom of the support 300 is adapted to firmly stand on a flat surface. The support 300 is adapted to support the holder 1 such that the holder 1, with the electronic device 400 held therein, can be disposed above a flat surface due to the height of the support 300. As an end, an operation of the electronic device 400 is facilitated.

Referring to FIGS. 2 and 5 again, in the embodiment, there is provided a cavity 130 in the back of the body 100 opposing the electronic device 400. The support 300 comprises a flexible arm 310, an adhesive member 350 formed on an underside of its bottom for firmly attaching to a flat surface, and a snapping projection 360 at a top end of the arm 310. The snapping projection 360 is adapted to insert into the cavity 130 for snappingly connecting to the body 100 and securing thereto. By configuring as above, the body 100 and the support 300 can be assembled or detached easily, resulting in a facilitation of use.

Referring to FIG. 2 again, in another embodiment of the invention the body 100 comprises a back panel 101 and a front cover 102. A space 140 is enclosed by the back panel 101 and the front cover 102. The space 140 is adapted to receive portions of the plates 210 retracted therein. Also, the plates 210 are adapted to extend from the space 140. The plates 210 and the body 100 are thus formed together. By configuring as above, once the electronic device 400 is placed in the holder 1, a user may retract portions of the plates 210 of the clamping assembly 200 into the body 100. As an end, the plates 210 together with the clamps 230 can fasten the electronic device 400 therebetween.

While the invention herein disclosed has been described by means of specific embodiments, numerous modifications and variations could be made thereto by those skilled in the art without departing from the scope and spirit of the invention set forth in the claims.

What is claimed is:

1. A device for holding an electronic device comprising:
a body comprising a base in its bottom, the base being adapted to support the electronic device;
a clamping assembly formed together with the body wherein both sides of the clamping assembly are adapted to retract toward or extend from the body; and
a plurality of clamps slidably connected to both sides of the clamping assembly and provided externally of the body.

2. The device of claim 1, wherein the clamping assembly comprises:
two plates; and
a locking assembly at a joining portion of the plates for connecting the plates together such that the locking assembly is adapted to operate to move the plates toward the body or away from the body.

3. The device of claim 2, wherein the clamp comprises a longitudinal slot at one end, the slot having a transverse section conformed to that of either side of the clamp externally of the body, and an opening at mouth of the slot to communicate the slot such that the clamp is adapted to slidably put on one side of the plate by sliding down along the slot and the opening.

4. The device of claim 2, wherein the plate comprises at least one transverse projecting bar at each of its bottom and top proximate the locking assembly, and wherein the locking assembly comprises:
at least one first resilient member each having one end put on either bar and the other end urged against the body;
a gear assembly at center of the clamping assembly; and
a return member comprising a shank having one end projected from a side surface of the body, a second resilient member urged against the other end of the shank, and a pawl projected from the shank toward the gear assembly wherein in response to retracting the plates toward the body, the gear assembly is driven to rotate with the first resilient members being compressed and the pawl being caught and held by the gear assembly, and in response to stopping retracting the plates, the pawl disengages with the gear assembly for enabling the plates to extend from the body by expanding the first resilient members.

5. The device of claim 4, wherein each of the plates comprises a hole disposed corresponding to the gear assembly, one plate further comprises a toothed bar above its hole, and the other plate further comprises a toothed bar below its hole, and wherein the gear assembly comprises:
a first gear comprising a central first connecting member, the first gear being adapted to mesh with the lower toothed bar wherein in response to retracting the plates toward the body, the first gear is driven to rotate, and in response to stopping retracting the plates, the first gear assembly is held motionless with the first resilient members being maintained in its compressed state; and
a second gear comprising a central second connecting member, the second gear being adapted to mesh with the upper toothed bar wherein the first and second connecting members are secured together in one hole such that the first and second gears are able to rotate the same.

6. The device of claim 1, wherein the base comprises:
a lengthwise rail along one surface; and
a plurality of support members each having a groove proximate one end, the groove having a longitudinal section conformed to that of the rail such that the support member is adapted to put on the rail by inserting the rail through the groove.

7. The device of claim 1, further comprising a substantially upright support opposite the electronic device held in the body and wherein bottom of the support is adapted to firmly stand on a flat surface.

8. The device of claim 7, wherein the body further comprises a cavity in its back opposing the supported electronic device, and the support comprises a flexible arm, an adhesive member on an underside of its bottom for firmly attaching to a flat surface, and a snapping projection at a top end of the arm, the snapping projection being adapted to insert into the cavity for securing the support and the body together.

9. The device of claim 2, wherein the body consists of a back panel, a front cover, and a space enclosed by the back panel and the front cover, and wherein the space is adapted to receive portions of the plates retracted therein, the plates are adapted to extend from the space, and the plates and the body are formed together.

10. The device of claim 2, wherein the clamp is adapted to pivot about one side of the plate, and wherein the clamp is adapted to pivot away from the body.
